(19) United States
(12) Patent Application Publication
(10) Pub. No.: US 2007/0005359 A1
(43) Pub. Date: Jan. 4, 2007

(54) Method for transmitting transactional commands and data between computer networks

(76) Inventor: David Bowen, Kars (CA)

Correspondence Address: SMART & BIGGAR;P.O. BOX 2999, STATION D, 900-55 METCALFE STREET, OTTAWA, ON, K1P5Y6, CA

(21) Appl. No.: 11/477,480

(22) Filed: Jun. 30, 2006

Related U.S. Application Data
(60) Provisional application No. 60/695,012, filed on Jun. 30, 2005.

(51) Int. Cl. G10L 15/04

(52) U.S. Cl. 704/251

(57) ABSTRACT

The present invention relates to a method for transmitting transactional commands and data between computer networks, and in particular a method for securely transmitting transactional commands and data between two computer networks by encoding the transaction based upon the ontology and semantics of the transaction commands. The invention establishes the process in which transactional commands are decomposed into context less text, based upon a local representation of the transaction command ontology and semantics. The invention also establishes the process for authenticating the transaction using deep knowledge of the user and business rules for the transaction. The decomposition of the transaction command and data is achieved using command semantic knowledge objects, data semantic knowledge objects and a decision cube populated as a result of an examination of the transaction command set ontology and semantics. The resultant transmission consists of a set of indexes or tags and context less data fields.

### RELATED APPLICATIONS

This application claims the benefit of U.S. Provisional Patent Application No. 60/695,012 filed Jun. 30, 2005, which is hereby incorporated by reference in its entirety.

### FIELD OF THE INVENTION

The invention relates to methods of encoding transmissions comprising transaction commands and data between computer networks.

### BACKGROUND OF THE INVENTION

There is a growing need for new technologies to overcome shortcomings and issues with the existing Internet infrastructure. The difficulties inherent with the present Internet infrastructure include the transmission of web pages containing large amounts of data which are static. The time spent to encrypt and decrypt at both the client side and the server side rises for every additional byte of data transmitted. Since server scalability is necessitated by the amount of data being transmitted, the transmission of unnecessary data can substantially increase the cost of a service provider delivering services over the Internet. As well, the architecture for web services drives a large number of database accesses that are not required

With regard to security, the use of browser based technologies inherently expose information about network infrastructures. At the same time, service providers encounter competitive pressures to provide quality partner and customer access. There is therefore a need to protect the corporate network and information assets from unmanaged endpoints that are consistent sources of virus and worm infections. As well, there is also a need to improve access to information securely and quickly to better support the demand for cost effective Online Transactional Processing (OTP). There is also a need for visibility, reduced complexity and improvements in Business to Business (B2B) and Business to Consumer (B2C) process management.

With regard to communications between the Internet and an organization's private network (Intranet), current communication methods do not enable data access from outside an organization's Intranet with the access being controlled at the transaction or data element level. Existing web services can provide access to these types of private networks on a page by page basis, using Secure Socket Layer (SSL) and the transaction will be relatively secure during the transit over the Internet. However, the applications that are used in these transactions (i.e. a web browser and a web server) have repeatedly been shown to have serious security flaws. Other communication methods, such as Virtual Private Networks (VPN), provide a mechanism to grant secure access to specific users on specific machines. More recent VPNs that use SSL technology allow a user to change machines but still have access to all of a network's resources.

Coalition capable netcentric systems require the ability to provide different levels of information depending on the network access point and the end user. This is referred to as multi level security and requires a concept called data guards. Data guards use the identity of the user and the access point to determine what information can pass between different security levels.

However, a goal remains to provide a more efficient and secure means of transmitting information to/from client and server devices. More particularly, it is desired to provide a method to allow web developers or application developers to control the data and the types of transactions that a user can perform with greater security.

### SUMMARY OF THE INVENTION

In some embodiments, the present invention comprises some or more of the following steps at the client side: (i) identify the end user; (ii) authenticate the end user; (iii) provide access control based on the identity of the end user; (iv) translate the user's request into encoded server commands and (v) send the encoded server commands to the appropriate remote server(s).

At the remote server side, the encoded server commands are received from the client side. These encoded server commands represent a request for a transaction to be performed, also known as a query. This request is analyzed by a query authentication function to validate that the client side has authorization to request the transaction and that the data being requested or submitted is within the scope of authorization. If so, the request is fulfilled, and the response is encoded and returned to the client side for processing.

According to one aspect of the present invention, there is provided a method of transmitting a request for a transaction to be performed to a remote computer network comprising the steps of: receiving said request; converting said request into context-less text; and transmitting said context-less text to said remote computer network.

In some embodiments, the method further comprises encrypting the context-less text.

In some embodiments, the method further comprises authenticating said request.

In some embodiments, the method further comprises determining the validity of said request.

According to another aspect of the present invention, there is provided a method of processing a request for a transaction to be performed from a local computer network comprising the steps of: receiving, at a remote computer network, context-less text; translating said context-less text into a computer executable command, said computer executable command being representative of said request for a transaction to be performed; executing said computer executable command; and outputting data in response to said computer executable command.

In some embodiments, the method further comprises converting said data into context-less text; and transmitting said context-less text to said local computer network.

In some embodiments, the method further comprises the step of decrypting the request.

In some embodiments, the method further comprises the step of validating said request.

In some embodiments, the method further comprises the step of authenticating said request.

In some embodiments, the method further comprises the step of encrypting the data.

According to yet another aspect of the present invention, there is provided a method of transmitting a request for a transaction to be performed to and from a remote computer network comprising the steps of receiving said request; converting said request into context-less text; transmitting said context-less text to said remote computer network; receiving, at the remote computer network, said context-less text; translating said context-less text into a computer executable command; executing said computer executable command; outputting data in response to said computer executable command; converting said data into context-less text, and transmitting said context-less text to a local computer network.

In some embodiments, the method further comprises encrypting said context-less data.

In some embodiments, the method further comprises comprising decrypting the context-less data.

In some embodiments, the method further comprises comprising validating said request.

In some embodiments, the method further comprises authenticating said request.

In some embodiments, the method further comprises encrypting the data.

In some embodiments, the step of converting said request into context-less text is performed with the use of a data anthology object which stores index, name and description objects.

In some embodiments, the step of converting the request into context-less text is performed with the use of a command anthology which stores index, name and description objects.

In some embodiments, the step of converting the request into context-less text is performed with a business rules anthology object which stores index, name and description objects.

In some embodiments, the method further comprises: querying a command anthology object; querying a business rules anthology object; and forwarding the resulting data to an authentication object.

In some embodiments, the authentication object contains a matrix type object containing command and business rules for valid requests.

In some embodiments, the step of converting the request into context-less text comprises the steps of decomposing the transaction command into context-less text, based upon ontology and semantics stored in a command anthology object; and decomposing the associated data into context-less text, based upon ontology and semantics stored in a data anthology object.

In some embodiments, the step of translating said request from context-less text into a computer executable command comprises the steps of: converting context-less text into a transaction command based upon the ontology and semantics stored in a command anthology object and business rule anthology object; and, converting the context-less text into associated data, based upon ontology and semantics stored in a data anthology.

In some embodiments, the step of authenticating the request includes the steps of: querying a command anthology object; querying a business rules anthology; and forwarding the resulting data and user type to an authentication object.

In some embodiments, the authentication object contains a cube type object containing transaction commands, business rules and user types descriptions for valid requests.

In some embodiments, said request comprises a transaction command and data.

Other embodiments of the invention provide computer readable media having computer executable instructions stored thereon for execution by one or more computers, that when executed implement a method as summarized above or as detailed below.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Preferred embodiments of the invention will now be described with reference to the attached drawings in which:

FIG. 1 is a block diagram showing the secure transaction applications and their relationship to client applications and application servers in accordance with some embodiments of the present invention;

FIG. 2 is a block diagram showing the processes carried out at the end user and application server sides in accordance with some embodiments of the present invention;

FIG. 3A is a block diagram of the makeup of the data anthology, command anthology and business rules anthology employed in some embodiments of the invention

FIG. 3B is a block diagram of the Command Knowledge Builder in accordance with some embodiments of the present invention;

FIG. 3C is a block diagram of the database design of the business rule anthology in accordance with some embodiments of the present invention;

FIG. 3D is a block diagram of the database design of the command anthology in accordance with some embodiments of the present invention;

FIG. 3E is a block diagram of the database design of the data anthology in accordance with some embodiments of the present invention;

FIG. 3F is a block diagram of the Command Semantic knowledge object in accordance with some embodiments of the present invention;

FIG. 3G is a block diagram of the makeup of Command Context data element in accordance with some embodiments of the present invention.

FIG. 4A is a block diagram of the Command Knowledge Translator in accordance with some embodiments of the present invention;

FIG. 4B is a schematic diagram of a Decision Cube in accordance with some embodiments of the invention;

FIG. 5A is a block diagram of the Data Knowledge Builder in accordance with some embodiments of the present invention;

FIG. 5B is a block diagram of a data semantic knowledge object in accordance with some embodiments of the present invention;

FIG. 5C is a block diagram of the Data Context field in accordance with some embodiments of the present invention; and

FIG. 6 is a block diagram of the Data Knowledge Translator in accordance with some embodiments of the present invention.

### DETAILED DESCRIPTION OF THE PREFERRED EMBODIMENTS

The present invention involves the encoding of queries sent and received to/from client side and server side computer systems.

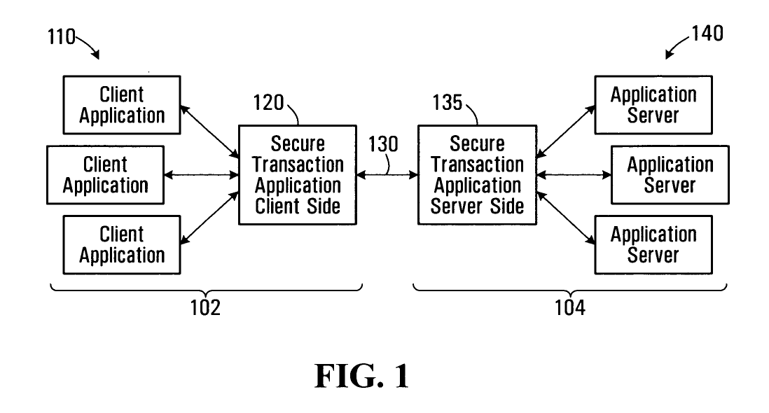

FIG. 1 is a block diagram showing the client side computer system 102 and the server side computer system 104 of the secure transaction application. The secure transaction application is comprised of a secure transaction application client side 120 and a secure transaction application server side 135. One or more client applications 110 can be serviced by the secure transaction application client side 120. Likewise, the secure transaction application server side 135 can access one or more application servers 140. Client application(s) 110 can, by means of secure transaction application client side 120, securely transfer transaction command(s)/request(s) and their associated data over an Internet Protocol (IP) network 130 to/from a secure transaction application server side 135 for processing by application server(s) 140.

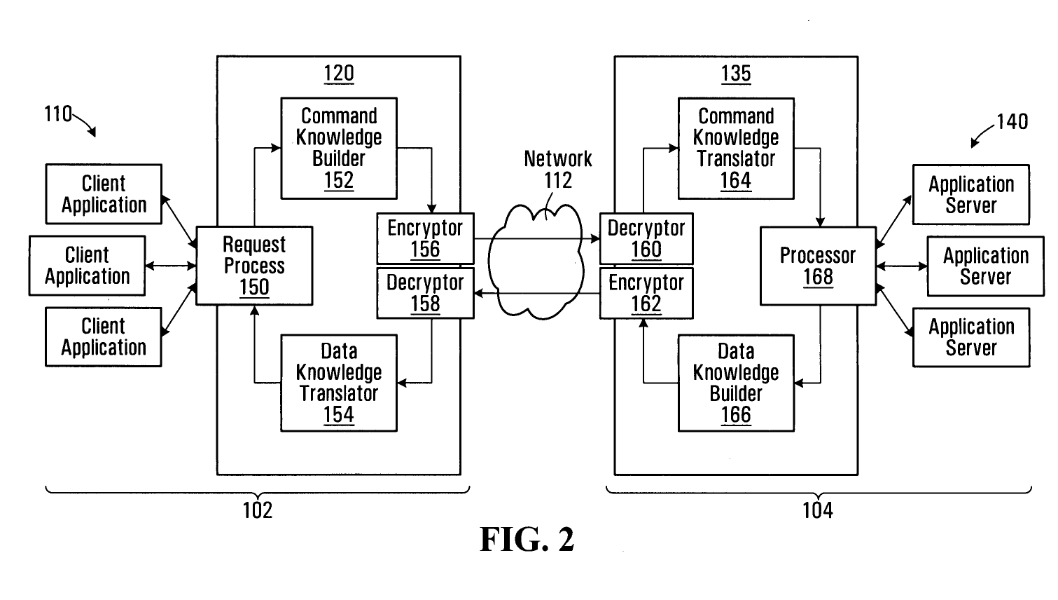

FIG. 2 is a block diagram showing further detail concerning the processes carried out by secure transaction application client side 120 and secure transaction application server side 135 than was shown in FIG. 1. Shown is Request Process 150 which receives a request for a transaction to be performed from one or more client applications 110. An example of such a request would be a request by an insured party for information relating to an insurance claim. In such an example, the request would include a user's name, address, date of birth, data claim submitted, amount of claim, etc. The user may submit this request for information via an online form or other requesting means. Note that data can be provided in the request for a transaction but is not necessary; it depends on the transaction.

The user's request for a transaction to be performed is further analyzed to ensure that there are no appended transaction requests and that the data is not an allowable embedded query. Once the command has been authenticated as being within the scope of the user and not containing additional out of scope queries, the user's request for a transaction to be performed invokes a call by Request Process 150 to Command Knowledge Builder 152 which passes on the call parameters and the identity of the calling application.

Command Knowledge Builder 152 is a process which converts the user's request and any other commands passed on by Request Process 150 into context-less text. The meaning of context-less test is explained in more detail below.

The Command Knowledge Builder 152 then forwards the context-less text as a datagram to encryptor 156 where it is encrypted and forwarded as a message over a network 112 such as the Internet. Encryption and decryption, as discussed herein, can be by any suitable method, including that provided by Data Encryption Standard (DES) functions which are well known in the art.

The encrypted datagram is received by decryptor 160 which forms a part of secure transaction application server side 104. Decryptor 160 decrypts the datagram and sends it to Command Knowledge Translator 164. Command Knowledge Translator 164 is a process which uses the user identification and the transaction indexes in the received datagram to verify using a decision cube that the datagram includes a valid request from a valid user.

If the requesting client is authenticated and the command with the data that was sent is authenticated, then processor 168 is passed the assembled command for further processing by application server(s) 140.

Processor 168 then receives a response to the user's request for a transaction to be performed from application server 140. This response is sent to Data Knowledge Builder 166 (i.e. a process that converts the response into context-less text), where a Data Semantic Knowledge object (not shown) is generated. The Data Semantic Knowledge object is then encrypted by Encryptor 162 and sent over network 112 to secure transaction application client side 120.

When secure transaction application client side 120 receives the packet, it is decrypted by Decryptor 158. Data is then retrieved from the Data Semantic Knowledge object using Data Knowledge Translator 154 which is a process that converts context-less text into data which verifies the data is appropriate for the transaction. The resulting data is then sent to request process 150 where it is sent to the appropriate client application which made the request for a transaction to be performed in the first place.

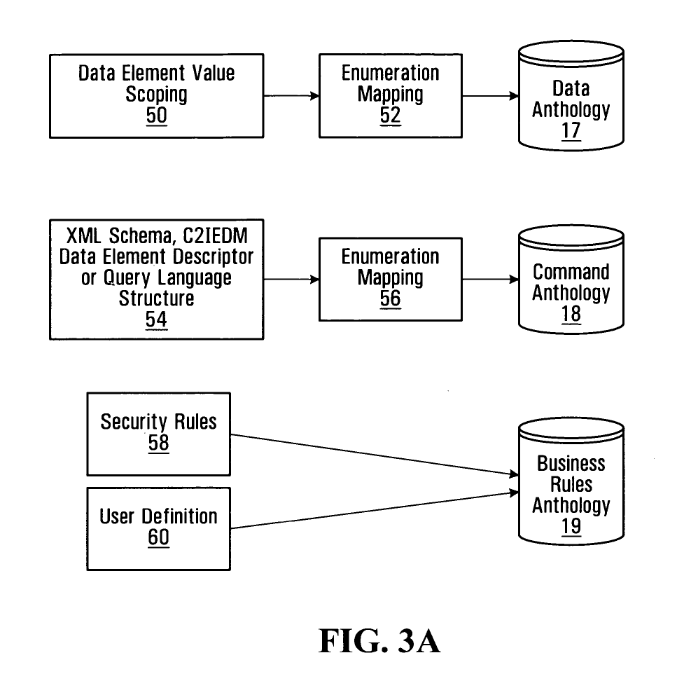

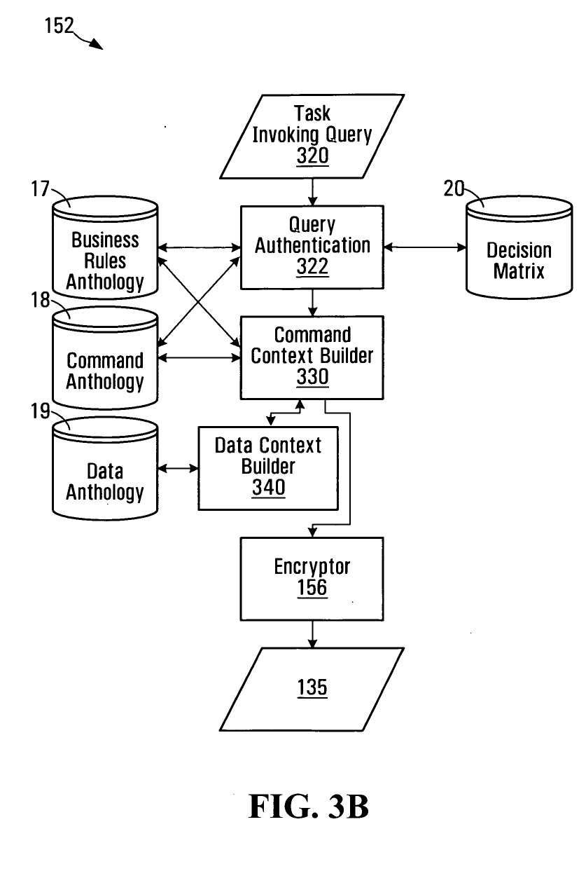

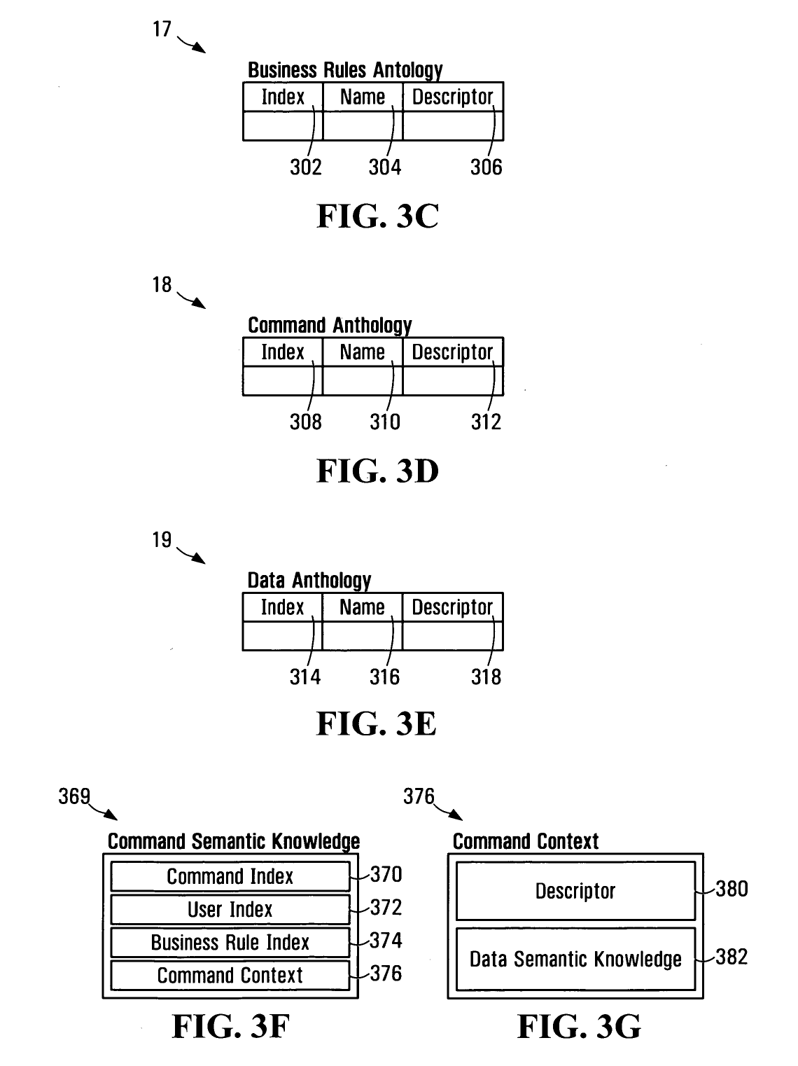

FIG. 3A is a block diagram of the makeup of data anthology 17, command anthology 18 and business rules anthology 19 employed in some embodiments of the invention.

A query is composed of commands, data and a structure that enables commands to be interpreted. Security rules govern what the user can request. In this system, data elements 50 are mapped into enumeration values 52 and plotted into data anthology 17. This data mapping identifies the data type, the range of acceptable values and the numeric value of the data. If the data is a string then the enumeration value for the string is passed.

For command anthology 18 the command is mapped into an enumeration value. For XML scheme and data descriptor schemas like C2IEDM 54, the data tag is mapped to a enumeration 56. For a query language, the query elements are mapped to an enumeration value. The security rules 58 and the language grammar are used to develop a mapping of how commands fit together and what is legal in a command. In addition the constraints for the individual users re imposed on the legal structure and range for the commands. The user identification 60 and the access points are used to further restrict the security rules.

Command Knowledge Builder

FIG. 3B is a block diagram of the Command Knowledge Builder 152 and its relationship to the other processes of the present invention.

Command Knowledge Builder 152 includes three anthologies, or catalogs: business rules anthology 17 containing an anthology of business rules for the application to be serviced, command anthology 18 containing an anthology of commands for the application to be serviced, and data anthology 19, an anthology of data for the application to be serviced. FIG. 3C is a block diagram of the database design of business rule anthology 17. Shown is a data table mapping index list 302, to a list of business rule names 304, to a list of descriptions for the business rules 306. Similarly, FIG. 3D is a block diagram of the database design of command anthology 18. Shown is a data table mapping index list 308, to a list of command names 310, to a list of descriptions for the command names 312. Finally, FIG. 3E is a block diagram of the database design of data anthology 19. Shown is a data table mapping index list 314, to a list of data types 316, to a list of data descriptions 318.

Business rules anthology 17 is a data structure that contains metadata about the business rules used in an application and rules for converting transaction requests into context-less text. Command anthology 18 is a data structure that contains metadata about commands and the rules for converting them into context-less text. Data anthology 19 is a data structure that contains meta data about the type of data, and rules for converting the data into context-less text. For example numeric data is converted to number a string of numbers defining the type of number (integer, real etc.) and the absolute value of the number. String values are converted to a string code and an enumeration value representing the string.

Also shown in FIG. 3B is decision matrix 20 which is a pre-constructed data structure for individual users that contains information about available commands and their business rules for each user. Decision matrix 20 is used to authenticate user requests. By way of example, a request for information about one's own health insurance is authorized but a request for someone else's health insurance would not generally be authorized. A request for financial information is only authorized if the user has access to such information. The financial information that the user has access to is further constrained based upon the business rules stored by the server. The business rules are a set of rules that define the types of commands that a client can access and the scope of the data fields in the commands. It is used to restrict users to specific data fields and specific transactions.

FIG. 3B also includes Command Context Builder 330 which is responsible for converting a user's request for a transaction to be performed (which in some embodiments contains commands and text) into context-less text. Context-less text is completely indeterminate in meaning. Context-less text are simple elements, for instance an integer, string or character with no associated meaning to it and thus lacking in any relation to anything else. By contrast, business rules are information models expressing relations between elements thus providing a context. Data only becomes meaningful when it is supplied with relations which yield meaning to the data. As such, if context-less text is provided a certain context, it can be transformed back to meaningful information.

FIG. 3B also shows Data Context Builder 340. The function of this process is described in more detail below.

The operation of Command Knowledge Builder 152 is as follows. Upon receipt of a request from request process 150 (see FIG. 2), task invoking query 320 initiates a request to Query Authentication process 322. Using data submitted from request process 150, task invoking query 320 assesses the valid queries for the user from the business rules and Decision Matrix 20 and determines whether the data being submitted is within acceptable ranges for the command. If the transaction request and the data are valid, Query Authentication process 322 initiates a call to Command Context Builder 330.

Using Command Anthology object 18 and Business Rules Anthology 17, Command Context Builder 330 uses the anthology and semantic knowledge of the possible transactions to decompose the transaction into set(s) of indexes (that represent the transaction request, the data type being requested) and the data values.

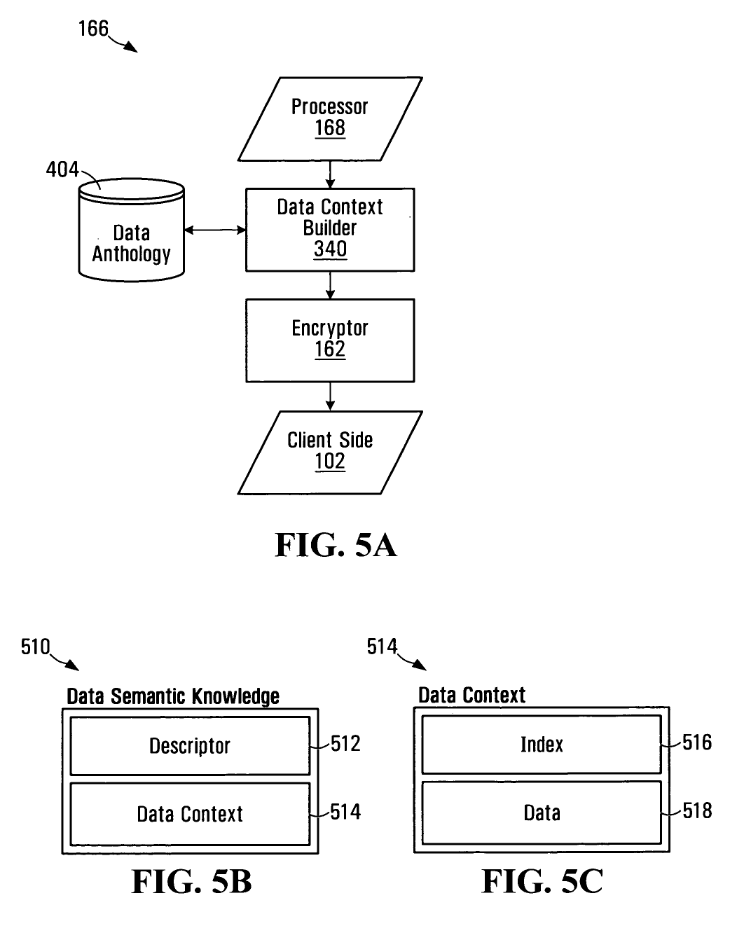

More specifically, Command Context Builder 330 queries the Command Anthology 18 using the command's name to create a Command Semantic Knowledge object 369 (see FIG. 3F). Based on the command's descriptor (which defines how many and what types of parameters are required for the execution of the command) Command Context Builder 330 calls Data Context Builder 340. Data Context Builder 340 receives the data supplied by request process 150 and uses Data Anthology 19 to convert the data into context-less text, i.e. Data Semantic Knowledge object 510 (see FIG. 5B). Data Context Builder 340 returns the Data Semantic Knowledge object 510 to Command Context Builder 330 where it becomes a part of the Command Semantic Knowledge object 369.

The make-up of a Command Semantic knowledge object 369 is shown in FIG. 3F. The Command Semantic Knowledge object includes: command index 370, user index 372, business rules index 374, and command context 376. The indexes and tags are unique for each application as they are created during application development.

The Command Semantic Knowledge object is then encrypted by encryptor 156 and forwarded to Secure Transaction Application server side 104 in the manner described above in connection with FIG. 2.

FIG. 3G is a schematic diagram of the makeup of Command Context 376. Command Context 376, containing Descriptor 380 and Data Semantic Knowledge 382, is a data element that maps each command (defined by the descriptor value) to the knowledge of how the command is constructed and used. Data Semantic knowledge 382 identifies the valid data for the command and the range acceptable for the user with respect to data with that command.

Command Knowledge Translator

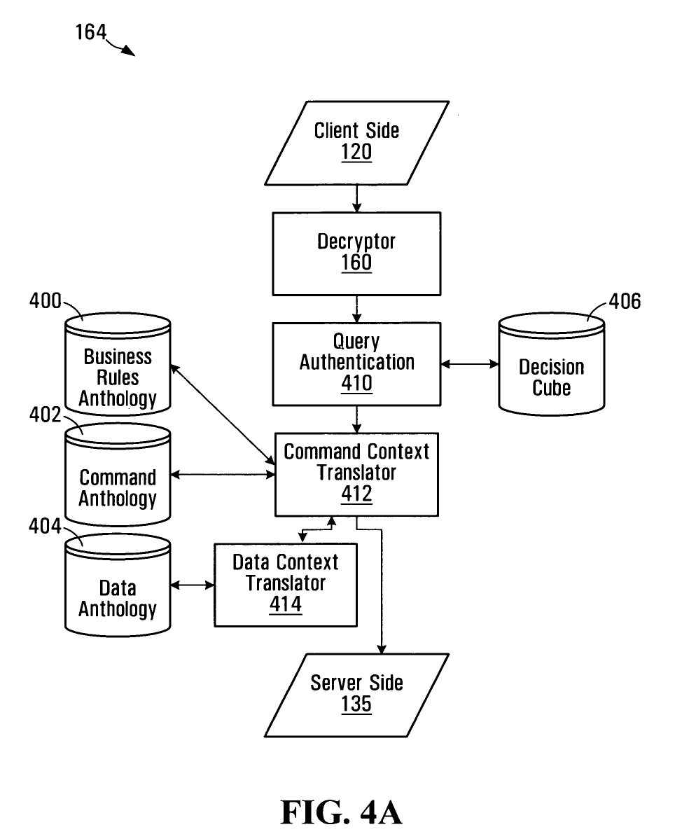

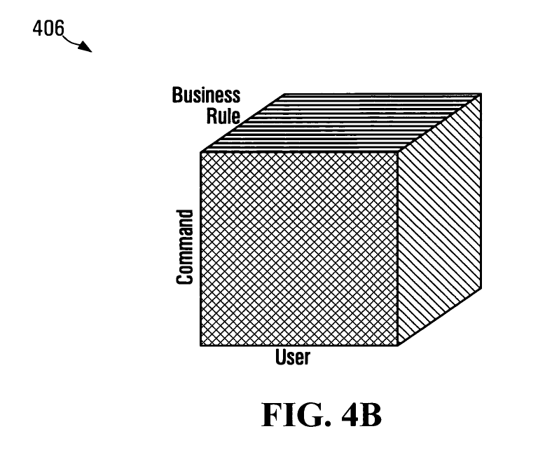

FIG. 4 is a block diagram of the Command Knowledge Translator 164. As with Command Knowledge Builder 152, Command Knowledge Translator 164 also includes three anthologies, business rules anthology 400 containing an anthology of business rules for the application to be serviced, command anthology 402 containing an anthology of commands for the application to be serviced, and data anthology 404, an anthology of data for the application to be serviced. These anthologies are similar to those described in connection with FIGS. 3A and 3B and will not be described further.

Command Knowledge Translator also includes Decision Cube 406, which is a pre-constructed data structure populated during the application development. FIG. 4B is a schematic diagram of Decision Cube 406 which is a matrix type object containing command and business rules for valid requests. In particular, Decision Cube 406 contains application specific rules about users, available commands and existing business rules. For each user that will access the server there is a slice within the cube. Within this slice there is a mapping of valid commands to the user as well as the scope of data accessible for each command. This enables an application on the server to validate that the user has access to the commands being sent and that the data elements being used in the transaction for that command are legal within the business and security rules for the user.

Command Knowledge Translator 164 also includes the following processes: Query Authentication 410, Command Context Translator 412, and Data Context Translator 414. The functions of these processes are described in more detail below.

In operation, query authentication 410 receives the Command Semantic Knowledge object 369 from Decryptor 160. Decision Cube 406 uses the User ID and the command and business rule indexes 370, 374 contained in Command Semantic Knowledge object 369 to authenticate the user and the transaction being requested. If the user request is authenticated, Command Context Translator 412 uses business rules anthology 400 and command anthology 402 to translate the context-less text into computer executable command(s) using the indexes in these databases. More specifically, Command Context Translator 412 queries Command Anthology 402 and Business Rules Anthology 400 using the index properties of Command Semantic Knowledge object 369. Based on the command and business rule descriptors in the respective anthologies, Command Context Translator 412 calls Data Context Translator 414 and passes the Data Semantic Knowledge object 510 (see FIG. 5B) parameter of Command Semantic Knowledge, for translation. Data context translator 414 is a sub function which reconstructs the data fields using the user identification, the data type index and the data value. Data Context Translator 414 receives the context-less text, i.e. Data Semantic Knowledge object 510, and using Data Anthology 404 reassembles the data into a format that has a context for application server(s) 140. Data Context Translator 414 returns data parameters in a format that can be used with the executable command. The command is reassembled and sent to processor 168 in a form such that it can be processed by the processor 168.

Data Knowledge Builder

FIG. 5A is a block diagram of Data Knowledge Builder 166. Data knowledge builder comprises data anthology 404 as well as a data context builder process 414. Data context builder process 414 uses data anthology 404 to create a data semantic knowledge object which is encrypted and sent to Secure Transaction Application client side 102.

FIG. 5B is a block diagram of data semantic knowledge object 510. Shown is Descriptor field 512 and Data Context field 514. Data descriptor field 512 defines the type of data being transmitted. In the case of a schema like XML or C2IEDM this field would contain an enumeration value that maps to a specific data tag. Data context field 514 links the data element to the use for the data. For example this field could indicate the units used to describe the data element along with a unit less value for the data. FIG. 5C is a block diagram of Data Context field which is comprised of index field 516 and data field 518.

The operation of Data Knowledge Builder 166 is as follows. Once processor 168 returns with the query/transaction results from application server(s) 140, Data Context Builder 414 uses data anthology 404 to assemble Data Semantic Knowledge object 510. Data Semantic Knowledge object 510 is created using the return parameter description provided by Command Knowledge Translator 164. Data Semantic Knowledge object 510 is then sent to encryptor 162 for forwarding to Secure Transaction Application client side 102. Data Semantic Knowledge object 510 contains an indication of the data type (eg. Temperature, SIN number etc.) number type (integer, char, etc) and the number or enumeration value or the string.

Data Knowledge Translator

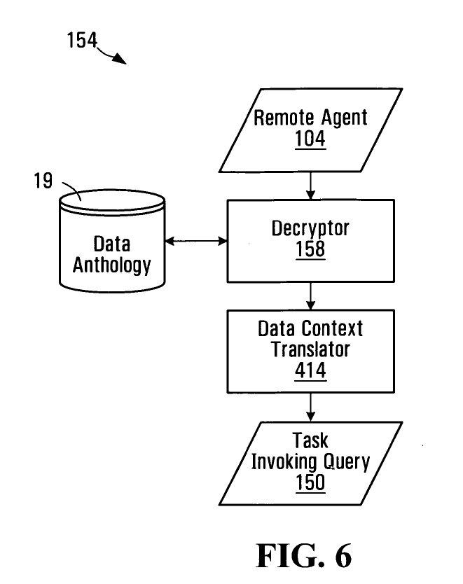

FIG. 6 is a block diagram of Data Knowledge Translator 154. Data Knowledge Translator is comprised of data anthology 19 and data context translator 414. Data Semantic knowledge object 510 is received from Secure Transaction Application server side 104 and is sent to decryptor 158. After decryption, Data Semantic knowledge object 510 is sent to data context translator 154 which uses data anthology 19 to convert the context-less text which comprises Data Semantic Knowledge object 510 into meaningful data. The output from data context translator 414 is a response to the user request in a format that the requesting client application 110 will understand. This response is sent to request process 150 for forwarding to the applicable client application(s) 110 which made the request in the first place.

The present invention has uses in storing and organizing document knowledge, as well as the development of knowledge based hash algorithms for performing queries using information and not words as the input.

In some embodiments, the present invention overcomes limitations and problems inherent with both web server technology and Secure Sockets Layer (SSL) Virtual Private Network (VPN) technology, and provides the security of SSL VPNs and the flexibility of web services. In particular, the specialized capabilities and enhanced performance over existing SSL VPN's, IPSec VPNs and web services include: (i) reducing the amount of data that needs to be sent between a server and a client side application; (ii) reduced overhead associated with encryption; (iii) reduced number of transaction requests to application server(s); (iv) double encryption; and (v) performing of deep data packet analysis to authenticate the contents of a packet before processing.

In some embodiments, the present invention will help facilitate (i) a cost-effective solution to corporate security needs; (ii) a standardized authentication service across an organization's applications; and (iii) scalability and robustness.

In some embodiments, all communications between the end user and the appliance are performed using Secure Sockets Layer (SSL) technology which is a protocol for transmitting secure documents via the Internet. In some embodiments, the present invention operates by means of software code which runs outside a web browser or links into custom applications on a client machine. In some embodiments, the present invention can also be used to implement data guards.

The present invention allows for client side processing of displayed web pages, significantly reducing the amount of data that needs to be transmitted between the server side and the client side. The present invention does not rely on an Hypertext Transfer Protocol (HTTP) server to communicate with the client and is significantly more secure than the HTTP server technology. The present invention can be securely deployed over the Internet by clicking on a link of a normal Hypertext Markup Language (HTML) page. Finally, the Graphical User Interface (GUI) can be made to look like a regular HTML page or can look like a Microsoft Windows™ application.

By using recent advances in VPN technology (based upon SSL technology) and by integrating the capabilities of remote procedure calls, extremely secure connections can be made between end users and business applications maintained inside an Intranet. Specifically, secure channels to enable executable interactions between clients and server applications can be created.

Numerous modifications and variations of the present invention are possible in light of the above teachings. It is therefore to be understood that within the scope of the appended claims, the invention may be practised otherwise than as specifically described herein.

1. A method of transmitting a request for a transaction to be performed to a remote computer network comprising the steps of:
receiving said request;
converting said request into context-less text; and
transmitting said context-less text to said remote computer network.

2. The method of claim 1 further comprising encrypting the context-less text.

3. The method of claim 1 further comprising authenticating said request.

4. The method of claim 1 further comprising determining the validity of said request.

5. A method of processing a request for a transaction to be performed from a local computer network comprising the steps of:
receiving, at a remote computer network, context-less text;
translating said context-less text into a computer executable command, said computer executable command being representative of said request for a transaction to be performed;
executing said computer executable command; and
outputting data in response to said computer executable command.

6. The method of claim 5 further comprising:
converting said data into context-less text; and
transmitting said context-less text to said local computer network.

7. The method of claim 5 further comprising decrypting the request.

8. The method of claim 5 further comprising validating said request.

9. The method of claim 5 further comprising authenticating said request.

10. The method of claim 6 further comprising encrypting the data.

11. A method of transmitting a request for a transaction to be performed to and from a remote computer network comprising the steps of:
receiving said request;
converting said request into context-less text;
transmitting said context-less text to said remote computer network;
receiving, at the remote computer network, said context-less text;
translating said context-less text into a computer executable command;
executing said computer executable command;
outputting data in response to said computer executable command;
converting said data into context-less text, and
transmitting said context-less text to a local computer network.

12. The method of claim 11 further comprising encrypting said context-less data.

13. The method of claim 11 further comprising decrypting the context-less data.

14. The method of claim 11 further comprising validating said request.

15. The method of claim 11 further comprising authenticating said request.

16. The method of claim 11 further comprising encrypting the data.

17. The method of claim 1 whereby the step of converting said request into context-less text is performed with the use of a data anthology object which stores index, name and description objects.

18. The method of claim 1 whereby the step of converting the request into context-less text is performed with the use of a command anthology which stores index, name and description objects.

19. The method of claim 1 whereby the step of converting the request into context-less text is performed with a business rules anthology object which stores index, name and description objects.

20. The method of claim 3 further comprising:
querying a command anthology object;
querying a business rules anthology object; and
forwarding the resulting data to an authentication object.

21. The method of claim 20 wherein the authentication object contains a matrix type object containing command and business rules for valid requests.

22. The method of claim 1 whereby the step of converting the request into context-less text comprises the steps of:
decomposing the transaction command into context-less text; and
decomposing the associated data into context-less text.

23. The method of claim 5, wherein the step of translating said request from context-less text into a computer executable command comprises:
converting context-less text into a transaction command based upon the ontology and semantics stored in a command anthology object and business rule anthology object; and,
converting the context-less text into associated data, based upon ontology and semantics stored in a data anthology.

24. The method of claim 9, wherein the step of authenticating the request includes:
querying a command anthology object;
querying a business rules anthology; and
forwarding the resulting data and user type to an authentication object.

25. The method of claim 23 wherein the authentication object contains a cube type object containing transaction commands, business rules and user types descriptions for valid requests.

26. A computer readable medium containing program instructions for execution by a computer for performing the method set forth in claim 1.

27. A computer readable medium containing program instructions for execution by a computer for performing the method set forth in claim 5.

28. A computer readable medium containing program instructions for execution by a computer for performing the method set forth in claim 11.

30. The method of claim 1 wherein said request comprises a transaction command and data.
